(19) United States
(12) Patent Application Publication
(10) Pub. No.: US 2012/0008273 A1
(43) Pub. Date: Jan. 12, 2012

(54) DISK DRIVE MOUNTING APPARATUS AND DISK DRIVE ASSEMBLY

(75) Inventor: ZHENG-HENG SUN, Tu-Cheng (TW)

(73) Assignee: HON HAI PRECISION INDUSTRY CO., LTD., Tu-Cheng (TW)

(21) Appl. No.: 12/848,195

(22) Filed: Aug. 1, 2010

(30) Foreign Application Priority Data
Jul. 12, 2010 (CN) 201010223942.8

(51) Int. Cl. G06F 1/16

(52) U.S. Cl. 361/679.33

(57) ABSTRACT

A disk drive mounting apparatus includes fasteners mounted to a disk drive, a support bracket, a retainer, and a locking member. The support bracket includes a plate engaged with the fasteners. A locking hole is defined in the plate. The retainer includes a retaining segment abutting against the plate, a clamping segment parallel to the retaining segment to sandwich the disk drive with the retaining segment, and a restriction segment connected between the retaining segment and the clamping segment. An engaging hole is defined in the retaining segment, corresponding to the locking hole. The locking member extends through the engaging hole to engage in the locking hole.

### BACKGROUND

1. Technical Field

The present disclosure relates to a disk drive assembly having disk drive and disk drive mounting apparatus.

2. Description of Related Art

With the miniaturization of electronic devices, the interior space of electronic devices is becoming more and more crowded. Thus, there is a need to take a lot of effort toward saving the interior space of the electronic devices.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an exemplary embodiment of a disk drive assembly.

FIG. 2 is an exploded, isometric view of the disk drive assembly of FIG. 1.

FIG. 3 is an enlarged, isometric view of a fastener of the disk drive assembly of FIG. 2.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

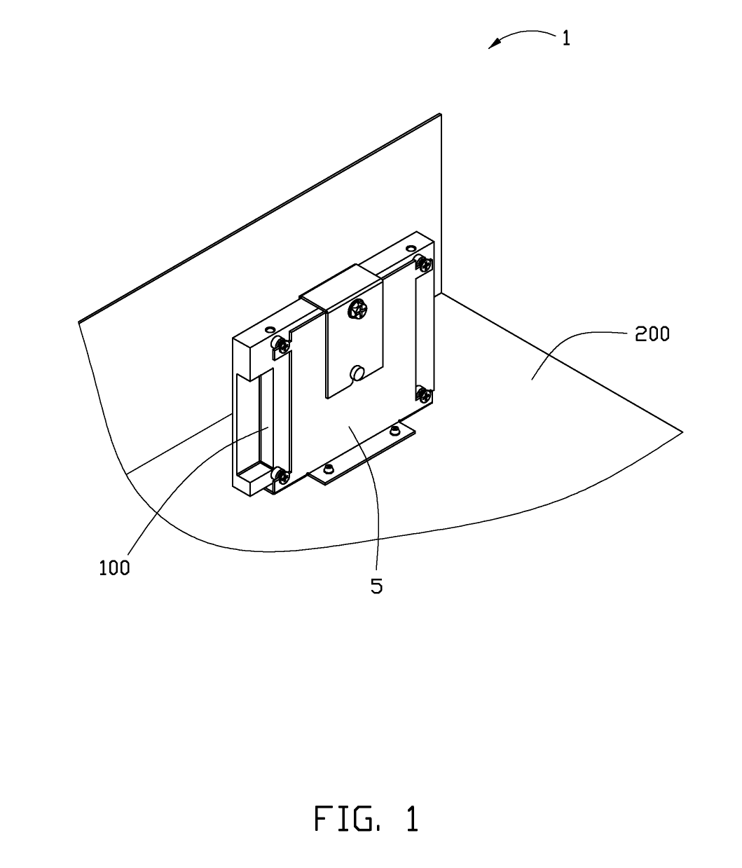

Referring to FIG. 1, an exemplary embodiment of a disk drive assembly 1 includes a disk drive 100, an enclosure 200 of an electronic device, and a disk drive mounting apparatus 5 for perpendicularly installing the disk drive 100 within the enclosure 200. A portion of the enclosure 200 is only shown in the drawings for illustration. In this embodiment, the enclosure 200 of the electronic device is a computer enclosure.

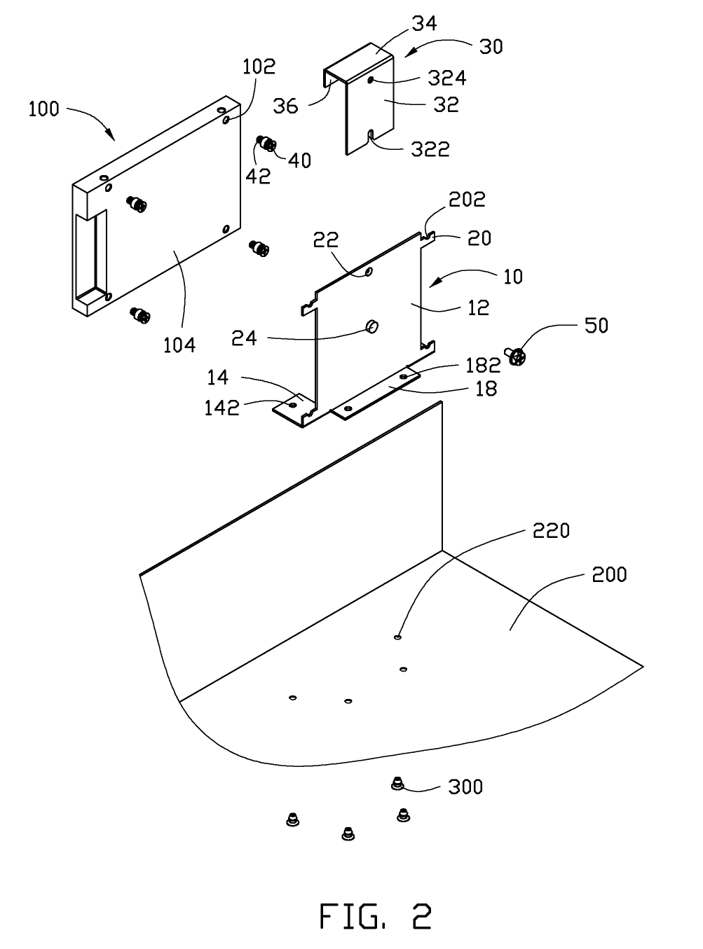

Referring to FIG. 2, a plurality of mounting holes 102 is defined in a side surface 104.

A plurality of mounting holes 220 is defined in the enclosure 200.

The disk drive mounting apparatus 5 includes a support bracket 10, a retainer 30, a plurality of fasteners 40, and a locking member 50.

The support bracket 10 includes a rectangular plate 12. Two first mounting portions 14 and a second mounting portion 18 perpendicularly extend from a first side of the plate 12, respectively in two opposite directions. The first mounting portions 14 and the second mounting portion 18 are positioned on a common plane. A first mounting hole 142 is defined in each first mounting portion 14. Two second mounting holes 182 are defined in the second mounting portion 18. A plurality of tabs 20 extends out from two opposite ends of the plate 12, corresponding to the fasteners 40. A semicircular cutout 202 is defined in a side of each tab 20, which is away from the first side of the plate 12. A locking hole 22, corresponding to the locking member 50, is defined in a second side of the plate 12, opposite to the first side. A location pin 24 protrudes out from a center of the plate 12.

The retainer 30 includes a retaining segment 32, a restriction segment 34 perpendicularly extending from a first end of the retaining segment 32, and a clamping segment 36 perpendicularly extending from the restriction segment 34 and parallel to the retaining segment 32. An elongated sliding slot 322 is defined at a second end of the retaining segment 32, opposite to the first end. An engaging hole 324, corresponding to the locking member 50, is defined in the retaining segment 32, adjacent to the restriction segment 34.

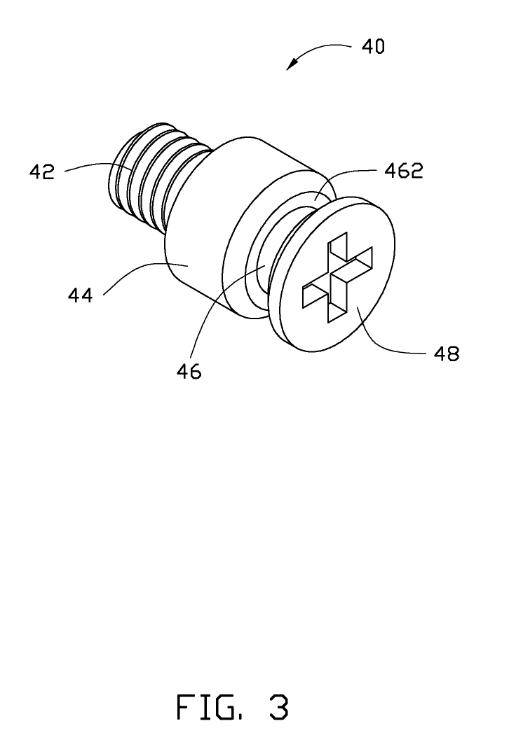

Referring to FIG. 3, each fastener 40 is substantially column-shaped, and includes a body 44, a threaded portion 42 extending from a first end of the body 44, a neck 46 extending from a second end of the body 44 opposite to the first end, and a head 48 extending from the neck 46 opposite to the body 44. A diameter of the neck 46 is smaller than diameters of the body 44 and the head 48, and thus a coupling groove 462 is bounded by the body 44, the neck 46, and the head 48.

In this embodiment, the locking member 50 is a screw.

Referring to FIGS. 1 and 2, in assembly, a plurality of mounting members 300, such as a plurality of rivets, respectively extends through the mounting holes 220 of the enclosure 200 and the corresponding first and second mounting holes 142 and 182 of the support bracket 10. Thus, the support bracket 10 is perpendicularly mounted to the enclosure 200. The threaded portions 42 of the fasteners 40 are respectively screwed in the corresponding mounting holes 102 of the disk drive 100. The necks 46 of the fasteners 40 are respectively received in the cutouts 202 of the corresponding tabs 20 of the support bracket 10, meanwhile, sides bounding the cutouts 202 are locked in the corresponding coupling grooves 462. Thus, the disk drive 100 is mounted to the plate 12 of the support bracket 10.

The retainer 30 is mounted to the disk drive 100 and the support bracket 10, with the retaining segment 32 of the retainer 30 abutting against the plate 12, the clamping segment 36 resisting against the disk drive 100 opposite to the retaining segment 32, and the restriction segment 34 supported on the disk drive 100. The location pin 24 of the plate 12 engages in the sliding slot 322 of the retaining segment 32. The engaging hole 324 of the retaining segment 32 is in alignment with the locking hole 22 of the plate 12, and the locking member 50 extends through the engaging hole 324 to be locked in the locking hole 22.

It is to be understood, however, that even though numerous characteristics and advantages of the embodiments have been set forth in the foregoing description, together with details of the structure and function of the embodiments, the present disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A disk drive mounting apparatus for a disk drive, the disk drive mounting apparatus comprising:
a support bracket comprising a plate, the plate defining a locking hole;
a plurality of fasteners to mount the disk drive to the plate;
a retainer comprising a retaining segment abutting against the plate, a clamping segment parallel to the retaining segment to sandwich the disk drive with the retaining segment, and a restriction segment connected between the retaining segment and the clamping segment; the retaining segment defining an engaging hole corresponding to the locking hole; and
a locking member extending through the engaging hole to engage in the locking hole.

2. The disk drive mounting apparatus of claim 1, wherein a slot is defined in the retaining segment, and a location pin protrudes out from the plate to engage in the slot.

3. The disk drive mounting apparatus of claim 1, wherein a plurality of cutouts is defined in the plate, corresponding to the plurality of fasteners; each of the plurality of fasteners includes a body, a threaded portion extending from a first end of the body to engage with the disk drive, a neck extending from a second end of the body to engage in a corresponding cutout of the plate, and a head extending from the neck opposite to the body.

4. The disk drive mounting apparatus of claim 3, wherein a plurality of tabs extends out from the plate, and the plurality of cutouts is respectively defined in the plurality of tabs.

5. The disk drive mounting apparatus of claim 3, wherein each of the plurality of fastener is substantially column-shaped, a diameter of the neck of each fastener is smaller than diameters of the corresponding body and head, and a coupling groove is bounded by the body, the neck, and the head.

6. The disk drive mounting apparatus of claim 1, wherein a plurality of mounting portions extends from a side of the plate, opposite to the restriction segment of the retainer; a mounting hole is defined in each of the plurality of mounting portions.

7. The disk drive mounting apparatus of claim 6, wherein the plurality of mounting portions is positioned on a common plane.

8. The disk drive mounting apparatus of claim 6, wherein the plurality of mounting portions extends in two opposite directions.

9. The disk drive mounting apparatus of claim 1, wherein the locking member is a screw.

10. A disk drive assembly comprising:
a disk drive;
an enclosure;
a support bracket mounted to the enclosure, and comprising a plate defining a locking hole;
a plurality of fasteners mounted to the disk drive and engaged with the plate; and
a retainer comprising a retaining segment abutting against the plate, a clamping segment parallel to the retaining segment to sandwich the disk drive with the retaining segment, and a restriction segment connected between the retaining segment and the clamping segment; the retaining segment defining an engaging hole, corresponding to the locking hole of the plate, a locking member extends through the engaging hole to be locked in the locking hole, thereby securing the disk drive to the enclosure.

11. The disk drive assembly of claim 10, wherein a plurality of cutouts is defined in the plate, corresponding to the plurality of fasteners; each of the plurality of fasteners includes a body, a threaded portion extending from a first end of the body and engaged in the disk drive, a neck extending from a second end of the body and engaged in a corresponding cutout of the plate, and a head extending from the neck opposite to the body.

12. The disk drive assembly of claim 11, wherein each of the plurality of fasteners is substantially column-shaped, a diameter of the neck of each fastener is smaller than diameters of the corresponding body and head, and a coupling groove is bounded by the body, the neck, and the head.

13. The disk drive assembly of claim 11, wherein a plurality of tabs extends out from the plate, and the plurality of cutouts is respectively defined in the plurality of tabs.

14. The disk drive assembly of claim 10, wherein the support bracket is perpendicularly mounted to the enclosure.

15. The disk drive assembly of claim 14, wherein a plurality of mounting holes is defined in the enclosure, a plurality of mounting portions extends from the plate, opposite to the restriction segment; a mounting hole is defined in each of the plurality of mounting portions, and a plurality of mounting members respectively extends through the mounting holes of the enclosure to engage in the corresponding mounting holes of the mounting portions, thereby mounting the support bracket to the enclosure.

16. The disk drive assembly of claim 15, wherein the plurality of mounting portions is positioned on a common plane.

17. The disk drive assembly of claim 15, wherein the plurality of mounting portions extends in two opposite directions.

18. The disk drive assembly of claim 10, wherein the locking member is a screw.

19. The disk drive assembly of claim 10, wherein a slot is defined in the retaining segment, and a location pin protrudes out from the plate to engage in the slot.
